(19) United States
(12) Patent Application Publication
(10) Pub. No.: US 2007/0110980 A1
(43) Pub. Date: May 17, 2007

(54) Gypsum board liner providing improved combination of wet adhesion and strength

(76) Inventor: Ashok Harakhlal Shah, Midlothian, VA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/272,921

(22) Filed: Nov. 14, 2005

(51) Int. Cl. B32B 13/10; B32B 13/06; D03D 15/00; B32B 13/02; D02G 3/00

(52) U.S. Cl. 428/294.7; 442/17; 442/199; 442/200; 428/373

(57) ABSTRACT

A polymeric fibrous nonwoven liner for gypsum board having an improved balance of strength and wet bond strength, wherein the liner is thermally bonded and includes a mixture of lower-melting binder fibers and higher-melting fibers and the liner contacting the gypsum composition is mechanically worked to open up the pore structure and increase the bulk of a layer of the fibers on the mechanically worked surface to increase the penetration of the gypsum composition, thus increasing the wet adhesion between the gypsum composition and the liner.

### BACKGROUND OF THE INVENTION

1. Field of the Invention

The present invention relates to an improved gypsum-based product faced on at least one side thereof with a thermally bonded polymeric nonwoven sheet that has improved wet bond strength with the gypsum-based composition while at the same time providing a gypsum product having good strength properties.

2. Description of the Related Art

Gypsum board is traditionally manufactured in a continuous process wherein a gypsum slurry is first prepared in a mechanical mixer by mixing calcium sulfate hemihydrate (also known as calcined gypsum), water, and other agents. The gypsum slurry is deposited on a sheet (generally cellulosic paper) which usually has each edge scored or creased to facilitate the folding of the edges to make a sidewall of height equal to board thickness and a further flap of width about 1 inch wide folded back over the board. An upper continuously advancing sheet (also generally cellulosic paper) is then laid over the gypsum slurry and the edges of the upper and lower sheets are pasted to each other using glue at the edges of the top and/or bottom sheet. The outer sheets and gypsum slurry are passed between parallel upper and lower forming plates or rolls in order to generate an integrated and continuous flat strip of unset gypsum sandwiched between the sheets that are known as facing sheets or liners. The sandwiched strip is conveyed over a series of continuous moving belts and rollers for a period of 2 to 5 minutes during which time the core begins to hydrate back to gypsum and hardens. During each transfer between belts and/or rolls, the strip is stressed in a way that can cause the paper facing to delaminate from the gypsum core if the adhesion between the gypsum core and the facing is not sufficient. Once the gypsum core has set sufficiently, the continuous strip is cut into shorter lengths or even individual boards or panels of prescribed length. Once again, it is important for there to be good adhesion between the paper sheets and the set, but still wet, gypsum core or the cutting action will pull the edges of the paper facing sheet away from the gypsum core. Good adhesion between the top and bottom paper sheet at the edges, which are pasted with glue, is also important.

After the cutting step, the gypsum boards are separated and grouped through a series of belts and rollers and then flipped over before being fed into drying ovens or kilns where the boards are dried so as to evaporate excess water. The hydration from hemihydrate to gypsum must be essentially complete by this point, normally between 7 and 15 minutes after mixing. When the gypsum boards are accelerated, flipped and fed into the drying ovens, the boards are subjected to a variety of stresses that can cause the facing to peel away from the gypsum core of the boards unless there is good adhesion between the set (but still wet) gypsum core and the facing material. Inside the drying ovens, the boards are blown with hot drying air at speeds up to 4000 feet/minute, which can cause further delamination of the paper facing if there is not good wet adhesion between the gypsum and the paper liners. If portions of the facing sheets delaminate from the gypsum core during drying in the oven, the liner can become entangled in the rollers and the gypsum crumbles as it dries, jamming the oven, which then requires the line to be shut down while the loose gypsum and liner is cleaned out of the ovens. Poor wet bond between liner and the gypsum core can also result in blisters due to delamination during the drying process. The gypsum boards are dried in the ovens for between about 30 to 75 minutes. After the dried gypsum boards are removed from the ovens, the ends of the boards are trimmed off and the boards are cut to desired sizes.

Sheet materials other than paper are also known in the art for use in preparing faced gypsum products. For example, commercially available gypsum board products utilize a glass mat in place of cellulosic paper liners. Such products are generally used for exterior uses but are less desirable for use in interior walls due to the surface properties of the glass mats.

Bruce et al., Canadian Patent No.1,189,434 discloses use of flash-spun facing sheets of Tyvek® flash spun polyethylene. Such a product has been found to have poor adhesive bonding between the liner material and the gypsum composition during the board manufacturing process and the liner also exhibits shrinkage during drying of the board since the conventional drying ovens used in gypsum board manufacture typically operate at temperatures above 150° C., which is above the melting point of the flash spun polyethylene sheet. Bruce et al. U.S. Pat. No. 6,485,821, which is incorporated herein by reference, also describes use of synthetic polymeric fibrous nonwoven sheets in the production gypsum boards. Suitable nonwoven sheets include needle punched staple fiber sheets, hydroentangled fibrous sheets, and spunbond sheets. Bruce et al. U.S. Pat. No. 6,800,361, which is hereby incorporated by reference, describes gypsum boards comprising a gypsum core held between two sheets of porous, fibrous polymeric nonwoven liner, wherein the work-to-break in-the machine direction (MD) of the nonwoven liner at a strain of 0.75 inch is greater than 30 lb-in. The nonwoven sheets can be comprised of thermally and/or chemically bonded melt-spun substantially continuous fibers such as spunbond webs, carded and/or air-laid staple fiber webs, needle punched staple fiber webs, hydroentangled webs, etc. Preferably the nonwoven liners comprise a mixture of monocomponent fibers and bicomponent fibers. The improved tensile strength of the liners contributes to improved mechanical properties of the gypsum board. The fibrous nonwoven sheet material used in the liners preferably have some fibers protruding from its surface on a microscopic level on at least one side thereof, which, when the gypsum board is produced, is the side placed in contact with the gypsum core. Shah, U.S. Patent Application Publication No. US 2005/0130541, which is hereby incorporated by reference also describes use of a polymeric nonwoven sheet liner that is preferably a mixture of monocomponent and bicomponent fibers that have been carded and/or air-laid and hydroentangled into a nonwoven sheet followed by bonding during drying and hot calendering.

An alternate method for improving the bond strength of a sheet material to a hardenable composition is described in Tesch U.S. Pat. No. 4,495,235. This patent describes forming a three-layer composite body having outer layers and a hardenable core layer such as gypsum, comprising a binder, by needling at least one outer layer comprising fibers which are capable of active needling to needle bond each with each other prior to the hardening of the binder so that the layers are held together in the deformable state. By means of the needle bonding of the unhardened composite structure consisting of individual layers and core layer, a plurality of holding fibers may be inserted in a relatively high density into the composite structure. The mat shaped composite has its own internal coherence and may be handled and freely suspended without a carrier or support surface. This process requires the incorporation of a needle bonding apparatus into the gypsum board forming process since needling occurs after the fibrous mats and gypsum core are arranged in a layered assembly.

Good adhesion between the facing sheets is critical during the various stages of gypsum board manufacture in order to prevent delamination of the sheet from the gypsum composition it is adhered to. Wet adhesion is generally achieved by allowing moderate penetration of gypsum slurry into the liner structure without complete penetration of the gypsum slurry to the other side of the liner (slurry seepage). The pore size of the liner should be large enough for ease of slurry penetration, but not so large to allow slurry seepage.

The nature of the inner surface of the facing sheet can impact the wet and dry adhesion properties of the board, for example fibers extending from the surface of the sheet on a microscopic level can provide some improvement via formation of a mechanical bond with-the gypsum composition.

It is also desirable that the liner has sufficient mechanical properties that the final board will also have good mechanical properties. Strength properties can be impacted by the degree of bonding of the liner. For example, the strength of a polymeric fibrous nonwoven liner can be developed by thermal bonding using fusible fibers during hot calendering or other thermal bonding processes such as through-air bonding. Other methods for bonding nonwovens to increase strength include hydroentangling with high-pressure water jets and needle punching. Hydroentangled nonwoven fabrics comprising fusible binder fiber generally have reasonable strip tensile strength prior to thermal bonding and thus require only moderate levels of hot calendering or some other form of thermal bonding in order to achieve an additional improvement in mechanical properties of the final gypsum board. Since hot calendering generally results in a reduction in the openness of a fibrous structure, more highly calendered fabrics may have unacceptable wet bond strength with a gypsum composition due to insufficient penetration of the gypsum into the fabric.

There remains a need for improved sheets for use as gypsum board liners that have improved wet bond strength as well as good mechanical properties.

### SUMMARY OF THE INVENTION

This invention is directed to a gypsum board having a gypsum core sandwiched between and adhered to first and second sheet-like liners which form the outer surfaces of the gypsum board, wherein at least the first liner is a thermally bonded nonwoven sheet having an inner surface and an outer surface and comprising a mixture of higher-melting fibers and binder fibers, wherein the binder fibers comprise a first lower-melting polymeric component comprising at least a portion of the peripheral surfaces thereof and which flow or soften sufficiently during thermal bonding to form thermal bonds at fiber cross-over points, with the higher-melting fibers comprising one or more higher-melting polymeric components which do not substantially melt or soften during the thermal bonding process, and wherein the inner surface of the thermally bonded nonwoven is mechanically worked after thermal bonding to provide a higher wet bond strength between the gypsum core and the liner than would have been achieved in the absence of the mechanical working step.

### DETAILED DESCRIPTION OF THE INVENTION

The present invention relates to liners suitable for use in preparing gypsum boards that have an improved combination of good wet bond strength and good mechanical properties (e.g. strip tensile strength and modulus). The present invention relates to liners suitable for use in gypsum boards, which provide an improved balance of strength and wet bond strength properties. The liners can be used in a standard gypsum board manufacturing process without the need to modify the process The terms “nonwoven fabric”, “nonwoven sheet”, “nonwoven layer”, and “nonwoven web” as used herein refer to a structure of individual strands (e.g. fibers, filaments, or threads) that are positioned in a random manner to form a planar material without an identifiable pattern, as opposed to a knitted or woven fabric. Examples of nonwoven fabrics include spunbond nonwoven webs, and staple-based webs including carded and air-laid webs, hydroentangled webs.

The term “hydroentangled nonwoven web” as used herein refers to a nonwoven fabric that is produced by entangling fibers in the web to provide a strong fabric that is free of binders. For example, a hydroentangled nonwoven fabric can be prepared by supporting a nonwoven web of fibers on a porous support such as a mesh screen and passing the supported web underneath water jets, such as in a hydraulic needling process. The fibers can be entangled in a repeating pattern.

The term “spunbond fibers” as used herein means fibers that are melt-spun by extruding molten thermoplastic polymer material as fibers from a plurality of fine, usually circular, capillaries of a spinneret with the diameter of the extruded fibers then being rapidly reduced by drawing and then quenching the fibers. Spunbond fabrics are generally prepared by collecting the spunbond fibers on a moving foraminous support surface.

The term “multiple component fiber” as used herein refers to a fiber that is composed of at least two distinct polymeric components that have been spun together to form a single fiber. The at least two polymeric components are arranged in distinct substantially constantly positioned zones across the cross-section of the multiple component fibers, the zones extending substantially continuously along the length of the fibers. Multiple component fibers are distinguished from fibers that are extruded from a single homogeneous or heterogeneous blend of polymeric materials

The term “bicomponent fiber” is used herein to refer to a multiple component fiber that is made from two distinct polymer components, such as sheath-core fibers that comprise a first polymeric component forming the sheath, and a second polymeric component forming the core; and side-by-side fibers, in which the first polymeric component forms at least one segment that is adjacent at least one segment formed of the second polymeric component, each segment being substantially continuous along the length of the fiber with both polymeric components being exposed on the fiber surface.

The term “monocomponent fiber” is used herein to refer to a fiber that is formed from a single polymeric component, or from a blend of polymeric components that can be homogeneous or heterogeneous as long as the components have a common melting point or softening point above the calendering/bonding temperature.

The term “polyester” as used herein is intended to embrace polymers wherein at least 85% of the recurring units are condensation products of dicarboxylic acids and dihydroxy alcohols with linkages created by formation of ester units. This includes aromatic, aliphatic, saturated, and unsaturated di-acids and di-alcohols. The term “polyester” as used herein also includes copolymers (such as block, graft, random and alternating copolymers), blends, and modifications thereof. Examples of polyesters include poly(ethylene terephthalate) (PET), which is a condensation product of ethylene glycol and terephthalic acid.

The term “polyamide” as used herein is intended to embrace polymers containing recurring amide (—CONH—) groups. One class of polyamides is prepared by copolymerizing one or more dicarboxylic acids with one or more diamines. Examples of polyamides suitable for use in the present invention include poly(hexamethylene adipamide) (nylon 6,6).

The term “polyolefin” as used herein, is intended to mean any of a series of largely saturated open chain polymeric hydrocarbons composed only of carbon and hydrogen atoms. Typical polyolefins include polyethylene, polypropylene, polymethylpentene, and various combinations of the ethylene, propylene, and methylpentene monomers.

The term “copolymer” as used herein includes random, block, alternating, and graft copolymers prepared by polymerizing two or more comonomers and thus includes dipolymers, terpolymers, etc.

The term “machine direction” (MD) is used herein to refer to the direction in which a nonwoven web is produced (e.g. the direction of travel of the supporting surface upon which the fibers are laid down during formation of the nonwoven web). The term “cross direction” (CD) refers to the direction generally perpendicular to the machine direction in the plane of the web.

The liner of the present invention comprises a thermally bonded porous nonwoven fabric formed from polymeric fibers, which comprises a mixture of higher-melting fibers and lower-melting binder fibers. The higher-melting fibers can be either monocomponent fibers or multiple component fibers. When the higher-melting fibers comprise multiple component fibers, the polymeric components of the multiple component fibers are selected to be higher-melting polymers that do not melt or soften to any substantial degree during thermal bonding of the fabric. The higher-melting polymer comprising the higher melting fibers preferably has a melting point of at least 150° C., more preferably at least 160° C. The nonwoven fabric can be staple-based such as those entangled by hydraulic needling or mechanical needling and which have been thermally bonded after entangling. Alternately, the nonwoven fabric can be made from continuous filaments such as spunbond fabric. The spunbond fabric can be lightly thermally bonded and wound up for further thermal bonding at a later time.

The fibers comprising the nonwoven fabric comprise about 20 to 80 weight percent, preferably about 40 to 60 weight percent of the higher-melting fibers with the remainder of the fibers in the nonwoven fabric predominantly comprising the binder fibers. The binder fibers can be monocomponent fibers consisting essentially of the lower-melting polymer or can comprise multiple component fibers wherein at least a portion of the peripheral surface comprises the lower-melting polymer. The nonwoven fabric preferably comprises about 10 to 40 weight percent of the lower-melting polymeric component of the binder fibers, more preferably about 20 to 30 weight percent of the lower-melting polymer, based on the total weight of the nonwoven fabric.

The binder fibers comprise a lower-melting polymeric component that has a melting point at least about 10° C. lower than the melting point of the higher-melting monocomponent fibers. The lower-melting polymeric component preferably has a melting point no lower than about 50° C. The lower-melting polymeric component comprises at least a portion of the peripheral surface of the binder fiber. The binder fiber can consist essentially of the lower-melting polymeric component. Alternately the binder fibers can comprise multiple component fibers. In one embodiment, the binder fibers comprise bicomponent sheath-core fibers, wherein the lower-melting polymeric component forms the sheath and a second higher-melting polymeric component forms the core. The ratio (based on weight) of the lower-melting sheath to the higher-melting core is preferably between 10:90 and 70:30, more preferably between 20:80 and 60:40.

The higher-melting polymeric component of the bicomponent binder fibers can be the same or different from the higher-melting polymer forming the higher-melting fibers in the web. The higher-melting polymeric core component of the binder fibers is preferably selected such that it does not substantially melt or soften during thermal bonding of the nonwoven fabric. The core thus contributes to improved strength in the bonded fabric. In another embodiment, the polymeric components in the binder fibers can be arranged in a side-by-side configuration. The higher-melting fibers preferably have a melting point no less than 150° C., more preferably no less than 160° C. so that they will not substantially melt or soften during the gypsum board manufacturing process, specifically during the drying process.

Examples of polymers suitable for use as the higher-melting polymer in the higher-melting fibers and in multiple component binder fibers include polyesters such as poly(ethylene terephthalate) homopolymer, polyamides such as nylon 6,6 homopolymer, and polyolefins such as polypropylene homopolymer. Polymers suitable for use as the lower-melting polymeric component of the binder fibers include polyester copolymers such as copolymers of poly(ethylene terephthalate), polyethylene and polypropylene.

Poly(ethylene terephthalate) copolymers suitable for use as the lower-melting polymeric component in the binder fibers include amorphous and semi-crystalline poly(ethylene terephthalate) copolymers. For example, suitable poly(ethylene terephthalate) copolymers in which about 5 to 30 mole percent based on the diacid component is formed from di-methyl isophthalic acid and poly(ethylene terephthalate) copolymers in which about 5 to 60 mole percent based on the glycol component is formed from 1,4-cyclohexanedimethanol. Poly(ethylene terephthalate) copolymers that have been modified with 1,4-cyclohexanedimethanol are available from Eastman Chemicals (Kingsport, Tenn.) as PETG copolymers. Poly(ethylene terephthalate) copolymers that have been modified with di-methyl isophthalic acid are available from E.I. du Pont de Nemours and Company (Wilmington, Del.) as Crystar® polyester copolymers.

Precursor nonwoven webs used to form the nonwoven webs of the present invention are made using methods known in the art. Staple-based precursor nonwoven fabrics can be prepared from fibrous webs that are formed using dry-lay techniques, such as one or more carded fibrous layers, one or more air-laid fibrous layers, or a combination thereof. Methods for preparing air-laid webs and carded webs are well known in the art. For example, air-laid webs can be made according to U.S. Pat. No. 3,797,074 to Zafiroglu or by using a Rando Webber manufactured by the Rando Machine Corporation and disclosed in U.S. Pat. Nos. 2,451,915; 2,700,188; 2,703,441; and 2,890,497, the entire contents of which are incorporated herein by reference. Staple fibers having a fiber length of about 30-75 mm and fiber denier of about 1-15 are generally preferred for preparing carded nonwoven webs. Staple fibers having a fiber length of about 12.7 mm-25.4 mm and fiber denier of about 0.9-4 are generally preferred for preparing air-laid nonwoven webs. The deniers of the binder fibers and higher-melting fibers are preferably closely matched for better processability. The higher-melting fibers and binder fibers can be admixed in the web during formation in carding, and the like, or by conventional textile blending techniques followed by carding the blended fibers. Alternately, a blend of fibers may be dispersed in an air stream and collected on a foraminous means in an air-laying process.

Continuous filament-based precursor nonwoven webs can be prepared using spunbond processes known in the art such as that described in Bansal et al. U.S. Pat. No. 6,548,341, and Rudisill et al. U.S. Pat. No. 5,885,909, which are hereby incorporated by reference.

The precursor webs comprising the higher-melting fibers and lower-melting binder fibers are thermally bonded using thermal bonding methods known in the art. In one embodiment, the precursor web is calendered in a nip between one or more pairs of rolls. One or both of the rolls can be heated. In one embodiment, the rolls are smooth rolls. The bonding pressure is generally about 17.5 to 70 N/mm. If desired, the precursor web can be pre-heated prior to calendering. In one embodiment, one of the calender rolls is a heated metal roll and the other is an unheated backing roll. The backing roll preferably has a resilient surface, for example a resilient material having a Shore D hardness of about 75-90. For example, densely packed cotton, wool, or polyamide rolls are suitable. Various roll arrangements are known in the art for calendering fabrics on one or both sides. For some applications such as outdoor applications, a patterned calender roll can be used to achieve point or pattern bonding by applying heat and pressure at discrete areas on the surface of the precursor web, for example by passing the web through a nip formed by a patterned calender roll and a smooth roll, or between two patterned rolls. One or both of the rolls are heated to thermally bond the fabric at distinct points, lines, areas, etc. on the fabric surface. Alternate thermal bonding methods include through-air bonding in which hot air is pulled or forced through the fabric, heating in a forced or circulating air oven, or combinations thereof. During the thermal bonding process, the lower-melting polymeric component of the binder fibers softens or melts and flows sufficiently to cause fiber-to-fiber thermal bonds to form at fiber crossover points. The thermal bonding is conducted under conditions such that the higher-melting fibers do not melt or soften to any substantial degree and they do not contribute to additional thermal bond formation. In the case where bicomponent binder fibers are used, it is desirable that the thermal bonding is carried out under conditions under which the higher-melting polymeric component of the binder component also does not melt or soften to any substantial degree.

Thermal bonding generally increases the strength and other mechanical properties of the precursor web, which is desirable when the fabric is used as a liner for gypsum board. However, thermal bonding tends to reduce the pore size of the fabric, thus reducing slurry penetration and the wet adhesion to the gypsum core. In some cases, such as when the precursor web is an entangled web (e.g., a hydroentangled web), the desired strength properties can be achieved with a moderate degree of thermal bonding since the entangling as well as the thermal bonds contribute to the fabric strength. At lesser degrees of calendering, the fabric structure remains more “open” with a larger pore size and provides acceptable adhesion, although improved adhesion in such cases is still desired.

When the precursor web is a spunbond web, higher degrees of thermal bonding (e.g. higher temperature and/or pressure during thermal calendering) are required in order to achieve the desired strip tensile strength. This results in a reduction in pore size in the fabric, which reduces slurry penetration and hence, wet adhesion as well.

According to the present invention, the thermally bonded precursor fabric is subjected to a further surface treatment comprising mechanical working of the surface in order to open up the pores at the surface of the fabric on one or both sides. Without being held to any particular theory, due to the presence of the higher-melting fibers which do not contribute to further formation of thermal bonds under bonding conditions described above, the fibers in the thermally bonded nonwoven sheet are more mobile under the influence of mechanical forces and the mechanical working of the surface causes the opening up of the fiber structure close to the surface. That is, a layer on the surface of the fabric undergoes an increase in pore size and bulk, which allows the gypsum slurry to better penetrate the surface of the liner. In one embodiment, the surface is contacted with a rotating or reciprocating brush (e.g. wire brush), which causes an opening of the surface. It should be pointed out that this results in a more “macroscopic” change in the fabric properties at the surface besides simply raising fibers from the surface. For example, in the case of continuous filament spunbond fabrics, in the absence of significant fibrillation of the fibers, there are few fiber ends present to protrude from the surface. Therefore, it is believed that the improvement in wet bond strength achieved by the present invention is due to more than simply raising fibers from the surface of the fabric. Other methods that can be used are conventional sanding, napping, and sueding equipment, so long as the processes are carried out under conditions that result in an increase in pore size to some depth into the fabric surface. The thermally bonded fabric can be mechanically worked on one or both sides, depending on the desired use. The presence of the higher-melting fibers results in unbonded sites throughout the fabric and makes it possible to achieve sufficient fiber mobility to allow the desired degree of opening of the fiber structure at the fabric surface during mechanical working to achieve the improved wet bond strength to the gypsum composition while at the same time maintaining good strength properties due to thermal bonding via the binder fibers.

In the embodiment wherein either the binder fibers or the higher-melting fibers are side-by-side fibers comprising incompatible polymeric components, the incompatible components can split during mechanical working. Splitable fibers can provide increased fabric bulk with less mechanical working compared to fibers that are not splitable.

Alternate methods that may be used to achieve a bulky layer on the surface of the thermally bonded nonwoven fabric of the present invention is to use differential bonding methods which bond one side of the liner to a different degree than the other side. For example, a relatively low level of bonding can be achieved on one side by exposing that side to relatively low bonding temperature, nip pressure, and/or residence time in a calendering process, followed by through-air bonding and hot calendering the other side of the fabric. Alternately, through-air bonding alone can be used to achieve differential bonding. The bonding can be done in such a way that one surface is more open to allow moderate gypsum slurry penetration at that surface which is placed in contact with the wet gypsum composition.

The mechanically worked thermally bonded liner is used on at least one side of a gypsum board. The liner on the opposite side of the gypsum core can comprise a second liner according to the present invention or may be selected from other sheet materials including, but not limited to, paper formed from cellulosic fibers, fabric or matt of glass fibers (continuous or discontinuous), other nonwoven fabric, film, woven fabric, scrim, or some combination thereof. If the gypsum board is used for interior applications, the outer surface of the liner (the side facing away from the gypsum composition), which forms the outer surface of the gypsum board, is preferably smooth for good paintability without requiring any additional surface preparation. If wallpaper is to be applied to the exposed surface of the gypsum board, mechanical working of the side of the liner opposite the gypsum composition may be helpful in improving adhesion to wallpaper, adhesive tapes, or other construction products, or in achieving a specific appearance such as a suede-like appearance.

The mechanically-worked nonwoven of the present invention can be combined with other sheet-like layers such as woven fabrics, foils, films, etc. and used as a liner for gypsum board so long as at least one side of the gypsum board has sufficient moisture vapor permeability to achieve efficient drying inside the drying oven during the board-forming process.

The mechanically worked nonwoven can be used in other applications, such as wallpaper. For example, the opened pore structure of the mechanically worked side of the paper can provide improved adhesion with the supporting structure such as gypsum wallboard. The mechanically-worked surface also can provide a desirable aesthetic look and feel and can be printed and/or embossed or laminated with woven, nonwoven, or films in a continuous or discrete manner for creating specific visual effects or to modify specific properties such as strength, light reflectance, thermal properties, etc.

### Test Methods

In the non-limiting examples that follow, the following test methods were employed to determine various reported characteristics and properties. ASTM refers to the American Society of Testing Materials. TAPPI refers to Technical Association of Pulp and Paper Industry.

Strip Tensile properties of nonwoven liners were measured according to ASTM 5035 using a CRE (constant rate of extension) Instron Tensile Tester (available from Instron Corporation of Canton, Mass.). The sample size used was 1 inch (2.54 cm) by 8 inch (20.3 cm); the gauge length was 5 inches (12.7 cm), and the speed was 2 in/min (5.1 cm/min). Peak load (lb) was measured using this method.

Basis Weight (BW) (weight per unit area, oz/yd² or g/m²) of the nonwoven liners was calculated according to ASTM D3776.

Thickness of the nonwoven liners was measured according to ASTM D1777.

The Melting Point of a polymer can be measured by differential scanning calorimetry (DSC) according to ASTM D3418-99, which is hereby incorporated by reference, and is reported as the peak on the DSC curve in degrees Centigrade. The melting point is measured using polymer pellets and a heating rate of 10° C. per minute.

Measurement of Breaking Characteristics of Gypsum Board:

The gypsum board samples were 8 in (20.3 cm) long and 4 in (10.2 cm) wide and were broken over a 7 in (17.8 cm) span on a Shimpo Model FGS-250PVM programmable motorized test stand (manufactured by Nidec-Shimpo America Corporation, Itasca, Ill.). The board is set in the test stand with one side of the board facing downward in contact with the two supports over a 7 in (17.8 cm) span, and the other side facing upward. The side of the board that faced downward during the board preparation as described above is also the downward-facing side of the board when breaking the board. The upward-facing side of the board is impacted with the center load when the board is being broken. While the board is being broken, the downward-facing side of the board (side opposite to the center load) primarily experiences tensile forces while the upward-facing side of the board in contact with the center load primarily experiences compressive forces.

A 50 lb (222.4 N) force gauge (resolution 0.01 lb (0.04 N), accuracy 0.02% plus ½ digit at 73° F. (22.8° C.)) was used for wet and dry bonding tests and a 500 lb (2224 N) force gauge (resolution 0.1 lb (0.04 N), accuracy 0.02% plus ½ digit at 73° F. (22.8° C.)) was used for the board breaking test measurements. The crosshead speed was 1.9 inches per minute (4.8 cm/min) with measurements taken every 0.2 seconds. Force in pounds vs. time in seconds was recorded at this constant crosshead speed to generate the stress-strain curve, also referred to as the breaking curve. The measurements were performed twice and the best value of the two breaking curves (force or load in pounds vs. deflection in inches) were reported as follows:

Initial Modulus (lb/in) was calculated as the initial slope of the force vs. deflection curve.

Yield Strength (lb) was calculated as the force corresponding to a significant decrease in the initial slope of the breaking curve.

Strain (inches) is the deflection of the board as calculated by time multiplied by the speed of the crosshead as described above.

Peak Load (lb) is the maximum force recorded during the breaking of the board.

Work-to-break (WTB) (lb-in) is calculated as the area under the breaking curve up to a given deflection. The total deflection is reported for WTB values reported in Table 2.

The Dry Bond Strength between the liner and the gypsum core was measured by pulling a 1 in wide by 1 in (2.54 cm×2.54 cm) long strip of the liner from the gypsum board at an angle of 90 degrees. The Shimpo Model FGS-250PVM programmable motorized test stand was used for this measurement. The crosshead speed was 1.9 in per minute (4.8 cm/min) with measurements taken every 0.2 seconds. Force in pounds vs. time in seconds was recorded at this constant crosshead speed with an average bonding strength being determined by averaging the force measurements taken in pulling a 1 in (2.54 cm) length of liner from the core. The measurements were performed twice, with the data measured every 0.2 seconds averaged, and the best average of the two curves (force or bond strength in pounds vs. distance in inches) was reported.

The Wet Bond Strength between the liner and wet gypsum slurry during board forming was assessed as follows. Gypsum slurry of desired formulation was first prepared by mixing all ingredients in a Waring Blender for 10 seconds. The gypsum slurry was then poured in a 0.5 in (1.27 cm) tall mold with the liner at the bottom. The wet adhesion, or the adhesive bond, between the liner and the wet slurry was assessed by pulling the liner away from the core 20 minutes after mixing in the same manner as dry bond measurement as described above except that the data was averaged over the one inch for only one sample.

The Board Weight was determined by weighing an 8″×8″ sample of the gypsum board and extrapolating the weight to the weight expected for a 1000 square-foot sample. This value was converted from pounds per thousand square feet to kilograms per 93 m².

### EXAMPLES

Preparation of GVpsum Board Samples

Gypsum boards reported in the following Examples were prepared as described below.

Two pieces of liner 14 in (35.6 cm) in length and 10 in (25.4 cm) in width were secured in a mold at one end, the two pieces being held apart by a spacer of thickness 0.5 in (1.27 cm). The mold was designed such that the open end of the mold was 1 in (2.54 cm) higher than the closed end of the mold, which helps to keep the slurry from running out the open end of the mold. The top of the mold was open initially to allow the top liner to be folded in place once the slurry was poured on the bottom liner. The edges were of height 0.5 in (1.27 cm) such that when the slurry was poured on the bottom liner, the slurry spread and the top liner put in place, a sample of width of 10 in (25.4 cm), thickness of 0.5 in (2.54 cm) and length of about 12 in (30.5 cm) was prepared.

The gypsum slurry formulation used in the examples consisted of 600 g of stucco (CaSO₄.½H₂O), 1 g of finely ground gypsum accelerator (CaSO₄.2H2O), 1 g of K₂SO₄, 130 ml of 4% Elvanol® 71-30 solution from Du Pont, 245 g of water and 150 g of foam solution. The foam solution was prepared by diluting Cedepal® FA406 (available from Stepan Chemicals) foaming agent with water to give a 0.5% solution by weight of foam concentrate.

To prepare a gypsum board, first a bottom liner was roller-coated with gypsum slurry without foam solution as follows: 600 g of stucco containing 1 g of finely ground gypsum (accelerator) the was sifted into 245 g of water in a Cuisinart Model CB-4J blender (made by Cuisinart, E. Windsor, N.J.) over a period of 30 seconds, and the mixture was mixed on high speed for 7 seconds. At this point, 50-75 ml of the mixture was quickly poured along one end of the mold on the back face of the bottom liner and a 10 in (25.4) wide trowel was used to spread the mix over the surface of the liner. Four passes of the trowel were made, giving good coverage with a coating depth of less than 1 mm and with some excess slurry pulled into the top end of the mold not used for the final sample. Separately, a foam solution was prepared by diluting Cedepal® FA406 (available from Stepan Chemicals) foaming agent with water to give a 0.5% solution by weight of foam concentrate. 75 ml of diluted foam solution was placed in the cup of a Hamilton Beach Model 65250 mixer and the mixer run at high speed to prepare the foam solution. Two mixers were used, with 75 ml of diluted foam solution in each mixer for a total of 150 ml of diluted foam solution. The foam mixers were started before the preparation of the stucco slurry and timed such that the foam would be mixed for about 1 minute before being used to prepare the board. At the required time, the foam was poured from the cups into the blender containing the gypsum slurry. Once the foam solution was added to the remainder of the stucco/water mix, the stucco/water/foam solution was mixed for an additional 7 seconds on high speed. The foamed mix was then poured on top of the coated liner in the mold. The slurry was struck off with a straight edge held about 1 mm above the top of the mold, the top liner folded into place and then the liner pressed into place with two passes of a second straight edge. The mold was tilted at a slight angle to prevent the slurry from pouring from the mold in the event the slurry was particularly fluid. When making a board without roller coating, the gypsum slurry of specific formulation is poured directly on the bottom liner. The board density is adjusted by adjusting the level of foam used in the slurry formulation.

After allowing the gypsum slurry to hydrate (about 20 minutes) the sample was carefully removed from the mold. The sample was trimmed to 8 in by 10 in (20.3 cm×25.4 cm), with the 8 in (20.3 cm) dimension being in the MD, or 14 in (35.6) liner dimension of the mold. The remaining 8 in×9 in (20.3 cm×22.9 cm) sample was then dried as follows.

The exposed core of the remaining 8 in×9 in (20.3 cm×22.9 cm) sample was covered by wrapping the edges with two thicknesses of 1 in (2.54 cm) wide cotton adhesive tape. The sample was dried in a convection oven at 475° F. (246° C.) until half of the free water was removed, and the oven was then reset to 225° F. (107° C.) until only about 5-10 percent of the free moisture remained in the sample. After 90-95% of the free water was removed, the temperature was reduced to 105° F. (41° C.) to finish drying the sample. Each sample was dried individually through the first two drying steps to ensure that the sample was dried in a consistent manner but was not over-dried. Free moisture was determined by mass balance.

After allowing the gypsum slurry to dry, a 1 in (2.54 cm) strip of the board was carefully cut from the 8 in×9 in (20.3 cm×22.9 cm) sample leaving an 8 in (20.3 cm) square sample. A 1 in (2.54 cm) wide sample was carefully cut from one edge of this sample for testing of dry bond. The sample was cut in half, with two pieces 4 in by 1 in (10.16 cm×2.54 cm) in size.

The 8 in (20.3 cm) square sample was cut in half to make two 4 in by 8 in (10.16 cm×20.3 cm) samples for testing breaking strength as described below. In all cases, the sample was cut such that the long dimension of the sample corresponded to the MD of the sample preparation process.

### Comparative Example 1

This example demonstrates the poor wet bond strength obtained when a 100% sheath/core bicomponent spunbond nonwoven web (low melting sheath) that has been hot calendered on both sides is used as a liner without mechanical working of the surface of the nonwoven sheet.

The liner of Example 1 was made using spunbond methods known in the art, as described in according to Bansal et al. U.S. Pat. No. 6,548,341. The spunbond nonwoven substrate was formed from 100% 50/50 by weight sheath/core bicomponent fibers, wherein the sheath was a poly(ethylene terephthalate) copolymer having a melting point of 180° C. while the core was poly(ethylene terephthalate) homopolymer with a melting point of 250° C. The fabric was lightly point bonded to provide sufficient mechanical integrity to withstand handling and further downstream processing. The spunbond sheet was hot calendered on a pilot line at BF Perkins, Rochester, N.Y. The hot calendaring was conducted at a temperature (205° C.), nip pressure (400 PLI) and residence time (2 seconds) suitable for achieving the optimum balance of strip tensile strength and bulk. During the hot calendaring, heat was applied to both sides of the liner. This was accomplished in two passes using a single nip formed by a heated smooth metal roll and an unheated smooth back-up roll. After the first pass through the nip to hot calender the first side of the fabric, the fabric was flipped over such that the second side was contacted with the heated roll in the second pass. In the examples below wherein only one side was hot calendered, only one pass through the nip was used.

A gypsum board sample was prepared as described above using the liner of Comparative Example 1 and wet bond strength was measured according to the procedure given in Test Methods. The wet bond strength was almost zero (not measurable) and is reported with other liner properties in Table 1 below. It is believed that high levels of bonding present in calendered fabrics made from 100% bicomponent binder-type fibers reduces the porosity of the fabric surface as well as the ability of the fibers near the surface to move in the presence of gypsum slurry, reducing the degree of gypsum slurry penetration into the fabric. Thus, although the liner fabric has good strip tensile strength and modulus, it has poor wet adhesion making it a poor candidate as a liner for gypsum boards.

### Comparative Example 2

This example demonstrates the poor wet bond strength obtained when a 100% sheath/core bicomponent spunbond nonwoven web (low melting sheath) that has been hot calendered on one side is used as a liner without mechanical working of the surface of the nonwoven sheet, with the unheated side adjacent the gypsum composition during manufacture of the gypsum board.

The liner of Comparative Example 2 was made in the same manner as Comparative Example 1 except heat was applied to only one side of the liner during the hot calendaring process on a pilot line at BF Perkins. Although the heat was applied to only one side of the sheet, the hot calendaring was conducted at a temperature, nip pressure, and residence time suitable for maximizing strip tensile.

The objective of this Example was to reduce level of bonding on the liner side opposite to heat application without sacrificing liner strength (strip tensile strength).

A gypsum board sample was prepared using the liner of Comparative Example 2 and wet bond strength was measured according to the procedure given in the Test Methods. The wet bond strength was almost zero and is reported along with other liner properties in Table 1 below.

It is believed that although heat was applied to only one side of the sheet during calendering that the fibers on the other side were sufficiently bonded at the surface to restrict fiber mobility and slurry penetration, thus resulting in poor wet adhesion.

### Comparative Example 3

This example demonstrates the poor wet bond strength obtained when a 100% sheath/core bicomponent spunbond nonwoven web (low melting sheath) that has been hot calendered on both sides is used as a liner after mechanical working of one surface of the nonwoven sheet.

The liner of Comparative Example 1 was mechanically worked using Mastercraft Wheel Cup 3 inch (7.6 cm) Fine Brush (Item 54-1307-0, manufactured by MasterCraft Canada, Toronto, Canada) at 100 RPM over 14 in×10 in (35.6 cm×25.4 cm) liner surface for 90 seconds.

A gypsum board sample was prepared using the liner of Comparative Example 3 such that the mechanically worked surface was in contact with the gypsum slurry during board preparation. Wet bond strength was measured according to the procedure given in the Test Methods. The wet bond strength was almost zero (no improvement in wet adhesion due to mechanical working). The wet bond strength is reported along with other liner properties in Table 1 below.

It is hypothesized that the mechanical forces were unable to break up or loosen up fibers at the surface and open up the liner pores at the surface of the liner of Example 1 because of the high degree of bonding due to the use of 100% bicomponent fibers. Due to the lack of any substantial opening of the fibers at the surface of the liner, no improvement in wet bond strength was observed.

### Comparative Example 4

This example demonstrates the impact of mechanical working on a spunbond liner that has been hot calendered on one side and mechanically worked on the side opposite the hot calendered side.

The liner of Comparative Example 2 was mechanically worked using Mastercraft Wheel Cup 3 inch (7.6 cm) Fine Brush (Item 54-1307-0) at 100 RPM over a 14 in×10 in (35.6 cm×25.4 cm) liner surface for 90 seconds. The mechanically worked side of the liner was the side that was not directly exposed to the heated roll during hot calendaring process.

A gypsum board sample was prepared using the mechanically worked liner of Comparative Example 4 such that the mechanically worked surface was in contact with the gypsum slurry. Wet bond strength was measured according to the procedure given in the Test Methods. The wet bond strength was almost zero (no improvement in wet adhesion due to mechanical working). The wet bond strength is reported along with other liner properties in Table 1 below. It is believed that due to the use of a high level (100%) of bicomponent fibers that the side of the spunbond fabric opposite that to which heat was applied during calendering was still sufficiently highly bonded to reduce fiber mobility and reduce the impact of mechanical working on the surface, thus resulting in no improvement in wet adhesion of the mechanically worked surface.

### Comparative Example 5

This example demonstrates the impact of blending higher-melting single component spunbond fibers with sheath/core spunbond fibers having a lower-melting sheath on the wet adhesion of a nonwoven sheet that has been hot calendered on two sides in the absence of mechanical working.

The liner of Comparative Example 5 was made in the same manner as Comparative Example 1 except the liner contained only 50 weight percent of the bicomponent fibers used in the liner of Comparative Example 1. The remaining 50 weight percent of the fibers were monocomponent fibers made of PET homopolymer having a melting point of 250° C.

A gypsum board sample was prepared using the liner of Comparative Example 5 and wet bond strength was measured according to the procedure given in the Test Methods. The wet bond strength was almost zero and is reported along with other liner properties in Table 1 below.

This example demonstrates that the use of a blend of 50/50 bicomponent fibers having a lower-melting sheath that provides bonding at fiber cross-over points during calendering and monocomponent fibers formed from a higher-melting polymer that does not melt during calendering is not by itself sufficient to achieve an improvement in wet bond strength. The degree of bonding is still sufficiently high to prevent significant movement of the fibers during contact with the gypsum slurry, resulting in low wet adhesion of the gypsum slurry to the nonwoven liner.

### Comparative Example 6

The liner of Comparative Example 6 was made in the same manner as Example 5 except that heat was applied to only one side of the liner during the hot calendaring process on a pilot line at BF Perkins. Efforts were made within the temperature limit of the heated rolls to raise the temperature of the side of the liner that was in direct contact with the heated roll high enough for effective bonding throughout the thickness of the liner. However, the strength data reported in Table 1 below clearly shows that the liner was not well bonded on the side that was not in direct contact with a heated roll during calendering.

A gypsum board sample was prepared using the liner of Comparative Example 6 by keeping the side of the liner having the lower degree of bonding in contact with the slurry. As shown in Table 1, wet bond strength was good due to a high level of unbonded fibers at the surface. The presence of unbonded fibers on the surface contacting the gypsum slurry allowed fiber movement and slurry penetration into the liner surface and thus increased the wet bond strength of gypsum slurry to the liner compared to a liner that has been thermally calendered on both sides. However, the improvement in wet bond strength achieved by unbonded fibers alone is of reduced practical value due to the low strength of the liner after hot calendering.

### Example 7

This example demonstrates the improvement in wet bond strength when higher-melting single component spunbond fibers are blended with sheath/core spunbond fibers having a lower-melting sheath in a nonwoven sheet hot calendered on both sides and mechanically worked on the side contacting the gypsum composition during board preparation.

The liner as used in Comparative Example 5 (50/50 bicomponent/monocomponent spunbond, thermally calendered on both sides) was mechanically worked on one side using Mastercraft Wheel Cup 3 inch (7.6 cm) Fine Brush (Item 54-1307-0) at 100 RPM over a 14 in×10 in (35.6 cm×25.4 cm) liner surface for 90 seconds.

A gypsum board sample was prepared using the liner of Example 7 by keeping the mechanically worked side in contact with the gypsum slurry. Wet bond strength was measured according to the procedure given in the Test Methods. As shown in Table 1, a significant increase in wet bond strength was realized due to the mechanical working of the surface. In addition, there was no substantial loss in liner strength due to mechanical working and thus, no negative impact on the strength properties of the gypsum board made therefrom. Board strength data are reported in Table 2 below. The visual appearance of the surface of the liner that was not mechanically worked remained unchanged. By reducing the degree of thermal bonding on the mechanically worked surface and providing some mobility to the fibers via use of a combination of monocomponent and bicomponent fibers, a bulky layer with opened pores was formed on the mechanically-worked surface to allow the gypsum slurry to better penetrate without substantially impacting the properties of the opposite side of the liner.

### Comparative Example 8

Instead of the spunbond liners used in previous examples, the liner of Comparative Example 8 was made by carding and air laying staple fibers on a belt, hydroentangling the carded/air-laid web, dewatering, drying and then hot calendering on both sides as described above.

The liner of Comparative Example 8 was prepared from 22 weight percent of lower-melting bicomponent staple fibers (denier 2.3, length about 1.5 inch, crimped) and 88 weight percent monocomponent PET homopolymer staple fibers (denier 1.2, length about 1.5 inch, crimped, melting point about 250° C.). The lower-melting bicomponent fibers had 50:50 ratio by weight of sheath to core. The sheath was made up of low melting poly(ethylene terephthalate) copolymer (melting point about 180° C.) while the core was higher-melting PET homopolymer (melting point about 250° C.).

Due to the fiber entanglement achieved via the hydroentangling process prior to hot calendaring, the percentage of binder fibers needed for achieving desired strength of the liner was lower than that used in the continuous filament spunbond liners of Examples 1-7 above, which relied solely on thermal bonding versus a combination of fiber entanglement and thermal bonding.

The liner of Comparative Example 8 had a sufficient level of bulk and suitable pore size and strength to provide sufficient wet adhesion to gypsum slurry during board forming process and good strength of the gypsum board made therefrom. Physical properties of the hot-calendered finished liner of Comparative Example 8 are given in Table 1 below.

A gypsum board was prepared using the liner of Comparative Example 8 and wet bond strength was measured according to the procedure given in Test Methods. The wet bond strength was acceptable (above minimum required for board forming process) as reported in Table 1. Board strength data are reported in Table 2.

### Example 9

A sample of the hydroentangled and calendered liner of Comparative Example 8 was mechanically worked using a Mastercraft Wheel Cup 3 inch (7.6 cm) Fine Brush (Item 54-1307-0) at 100 RPM over a 14 in×10 in (35.6 cm×25.4 cm) area of the liner surface for 90 seconds to form the liner of Example 9.

A gypsum board was prepared such that the mechanically-worked surface was in contact with the gypsum slurry. Wet bond strength was measured according to the procedure given in the Test Methods.

As shown by the data reported in Table 1, a significant increase in wet bond strength was achieved due to mechanical working, far exceeding the minimum wet bond strength required during the gypsum board forming process. Due to excessive mechanical working (more than required for desired improvement wet adhesion), there was a small loss in MD tensile strength of the liner, however there was no significant loss in the strength of the gypsum board made therefrom. Board mechanical properties remained good and are reported in Table 2 below.

Although the hydroentangled and calendered liner of Comparative Example 8 was marginally acceptable, the practical advantage of mechanical working is shown by the significantly higher wet bond strength of this Example 9. As such, normal variations in wet bond strength over entire liner surfaces in an extended production period would not produce localized areas having poor wet adhesion.

TABLE 1

| | LINER | | | | | | | | | | GYPSUM | |
|---|---|---|---|---|---|---|---|---|---|---|---|---|
| | Liner | | | 1- or 2-sided | | | Strip | Strip | Strip Tensile | | BOARD | |
| | Composition | | | heating | | | Tensile | Tensile | (MD + CD) per | | Wet | MD |
| | (weight %) | | Sheet | during | BW | Thickness | MD | CD | unit BW | | Bond | Strength |
| EX # | Bico | Monoco | Type | calendering | g/m² | mm | N/cm | N/cm | (N/cm/(g/m²)) | Mech. Working | N | N |
| 1 C¹ | 100 | 0 | SB3 | 2 sides | 108 | 0.17 | 105 | 60 | 1.5 | No | 0 | |
| 2 C | 100 | 0 | SB | 1 side | 108 | 0.13 | 135 | 56 | 1.8 | No | 0 | |
| 3 C | 100 | 0 | SB | 2 sides | 108 | 0.17 | 105 | 60 | 1.5 | Yes | 0 | |
| 4 C | 100 | 0 | SB | 1 side | 108 | 0.13 | 135 | 56 | 1.8 | Yes | 0 | |
| 5 C | 50 | 50 | SB | 2 sides | 108 | 0.16 | 108 | 43 | 1.4 | No | 0 | 190 |
| 6 C | 50 | 50 | SB | 1 side | 108 | 0.19 | 79 | 26 | 0.97 | No | 3.3 | |
| 7 | 50 | 50 | SB | 2 sides | 108 | 0.16 | 108 | 43 | 1.4 | Yes | 1.1 | 230 |
| 8 C | 22 | 78 | CD4 | 2 sides | 132 | 0.20 | 125 | 40 | 1.25 | No | 0.89 | 270 |
| 9 | 22 | 78 | CD | 2 sides | 132 | 0.20 | 104 | 40 | 1.1 | Yes | 3.5 | 260 |

¹C = Comparative Example
²SB = spunbond continuous filament nonwoven
³CD = Carded, cross-lapped, and hydroentangled staple-based nonwoven

TABLE 2

| | | | | Strain @ | | Strain @ | WTB (N-cm) | | | | | | | |
|---|---|---|---|---|---|---|---|---|---|---|---|---|---|---|
| | Avg. | Avg. | Peak | Peak | | Yield | Total for | | | | | | Initial | Board Wt. |
| Ex. | Wet | Dry | Load | Load | Yield | Load | 2 in | | 0.25 in | 0.5 in | 0.75 in | 1.0 in | Modulus | kg per |
| No. | Bond N | Bond N | N | cm | Strength N | cm | curve | To Yield | strain | strain | strain | strain | N/cm | 93 m² |
| 5 C¹ | 0.044 | 0.89 | 195 | 0.46 | 136 | 0.13 | 595 | 17 | 211 | 395 | 542 | 595 | 1420 | 752 |
| 7 | 1.1 | 4.0 | 230 | 3.22 | 176 | 0.18 | 968 | 12 | 104 | 233 | 364 | 506 | 1220 | 794 |
| 8 C | 0.89 | 14 | 273 | 2.36 | 196 | 0.15 | 985 | 15 | 130 | 294 | 441 | 578 | 1550 | 798 |
| 9 | 3.5 | 12 | 257 | 3.81 | 176 | 0.15 | 970 | 15 | 116 | 263 | 412 | 568 | 1440 | 787 |

¹C = Comparative Example

What is claimed is:

1. A gypsum board comprising a gypsum core sandwiched between and adhered to first and second sheet-like liners which form the outer surfaces of the gypsum board, wherein at least the first liner comprises a thermally bonded nonwoven sheet having an inner surface and an outer surface and comprising a mixture of higher-melting fibers and binder fibers, the binder fibers comprising a first lower-melting polymeric component comprising at least a portion of the peripheral surface thereof, the first lower-melting polymeric component flowing or softening sufficiently during thermal bonding to form thermal bonds at fiber cross-over points, the higher-melting fibers comprising one or more higher-melting polymeric components which do not substantially melt or soften during the thermal bonding process, and wherein the inner surface of the thermally bonded nonwoven is mechanically worked after thermal bonding to provide a higher wet bond strength between the gypsum core and the liner than would have been achieved in the absence of the mechanical working step.

2. The gypsum board of claim 1, wherein the higher-melting fibers comprise monocomponent fibers.

3. The gypsum board of claim 1, wherein the binder fibers comprise multiple component fibers.

4. The gypsum board of claim 3, wherein the multiple component fibers are splitable fibers.

5. The gypsum board of claim 3, wherein the binder fibers comprise bicomponent sheath-core fibers wherein the sheath comprises the first lower-melting polymeric component and the core comprises a polymeric component that is higher melting than the sheath.

6. The gypsum board of claim 5, wherein the nonwoven sheet comprises fibers selected from the group consisting of continuous fibers and staple fibers.

7. The gypsum board of claim 6, wherein the thermally bonded nonwoven sheet comprising staple fibers is web selected from the group consisting of thermally bonded hydroentangled nonwoven webs and thermally bonded needle punched webs.

8. The gypsum board of claim 7, wherein the nonwoven sheet is a hydroentangled nonwoven web.

9. The gypsum board of claim 5, wherein the nonwoven sheet comprises a thermally bonded spunbond web.

10. The gypsum board of claim 1, wherein the thermally bonded nonwoven sheet is a smooth calendered nonwoven sheet.

11. The gypsum board of claim 1, wherein the higher-melting fibers comprise polymers selected from the group consisting of polyesters, polyamides, and polypropylene and combinations thereof.

12. The gypsum board of claim 11, wherein the polymers comprising the higher-melting fibers have a melting point of no less than 150° C.

13. The gypsum board of claim 1, wherein the fibers in the nonwoven sheet comprise between about 20 and 80 weight percent of higher-melting fibers and the remainder of the fibers predominantly comprising the binder fibers, wherein the lower-melting polymeric component of the binder fibers comprises between about 10 and 40 weight percent of the total weight of the nonwoven sheet.

14. The gypsum board of claim 13, wherein the fibers in the nonwoven sheet comprise between about 40 and 60 weight percent of the higher melting fibers and the remainder of the fibers predominantly comprising the binder fibers, wherein the lower-melting polymeric component of the binder fibers comprises between about 20 and 30 weight percent of the total weight of the nonwoven sheet.

15. The gypsum board of claim 1, wherein both the inner and outer surfaces of the thermally bonded nonwoven sheet are mechanically worked.

16. The gypsum board of claim 1, wherein the mechanical working comprises contacting the inner surface of the thermally bonded nonwoven sheet with a rotating or reciprocating brush.
